(19) United States
(12) Patent Application Publication
(10) Pub. No.: US 2003/0063084 A1
(43) Pub. Date: Apr. 3, 2003

(54) System and method for improving 3D data structure representations

(76) Inventor: Gregory Michael Burke, Encinitas, CA (US)

Correspondence Address: FUESS & DAVIDENAS, Suite II-G, 10951 Sorrento Valley Road, San Diego, CA, 92121-1613, US

(21) Appl. No.: 10/260,930

(22) Filed: Sep. 27, 2002

Related U.S. Application Data
(60) Provisional application No. 60/326,132, filed on Sep. 28, 2001.

(51) Int. Cl. G06T 15/00

(52) U.S. Cl. 345/419

(57) ABSTRACT

The present invention is a system and method for migrating from a previous data structure for simulating surfaces of three dimensional objects to a new data structure that defines a surface of the three dimensional object in terms of contours. The contours sufficiently divide the surface such that an interpolative error between the contours is below a color error threshold and below a geometric error threshold.

### RELATION TO A PROVISIONAL PATENT APPLICATION

The present patent application is descended from, and claims benefit of priority of, U.S. provisional patent application Serial No. 60/326,132 filed on Sep. 28, 2001, having the same title, and to the selfsame inventor, as the present patent application.

### RELATION TO RELATED PATENT APPLICATIONS

The present patent application is related to U.S. patent application Ser. No. 10/219,953 filed on Aug. 14, 2002, for a SYSTEM AND METHOD FOR EFFICIENTLY CREATING A SURFACE MAP, and also to a U.S. patent application filed on an even date herewith for a SYSTEM AND METHOD FOR COMPRESSING IMAGE FILES WHILE PRESERVING VISUALLY SIGNIFICANT ASPECTS. Both related applications are to the same inventor as is the present application. The contents of the related patent applications are incorporated herein by reference

### BACKGROUND OF THE INVENTION

1. Field of the Invention

The present invention relates to data structures for generating two dimensional images of three dimensional objects. More particularly, the present invention relates to a technique for generating a new data structure from an old data structure that enables image quality to be improved while reducing processing requirements for generating images.

2. Description of Background Art

The application of compressing and rendering images of 3D objects or simulated objects is well known. One example is in video games, wherein a user alters an image of a three dimensional scene using an input device such as a joystick. The input device and the progression of the video game initiate the rendering of images depicting various 3D objects. To provide a view of the 3D object, the video game system has a data structure.

Typically the game system data structure approximates the surface geometry of a 3D object with triangles and the color and texture with texture maps. A surface of triangles together form an approximation of the 3D surface. The data structure stores each vertex of each triangle as an 8 or more dimensional variable including position (x, y, z), orientation (nx, ny, nz), and a texture map coordinate (Tu, Tv).

To provide texture and color, the data structure includes at least one 2D texture map for each 3D object. One way to think of a texture map is the visible surface of the 3D object flattened out into a two dimensional plot or pixel array. The texture map coordinates Tu, Tv map or relate positions on the texture map onto the triangle vertices so that a video processor system can properly approximate the visible surface of the 3D object.

This triangle/texture map methodology is illustrated with respect to FIGS. 1 and 2. FIG. 1 depicts a cylinder 2 that is to be part of a video game. The data structure defines the cylinder in terms of connected triangles 4. A single triangle 4 is depicted with respect to FIG. 2. The data structure stores each triangle vertex as a multidimensional variable, including x, y, z, nx, ny, nz, Tu, and Tv, wherein x, y, z are the rectangular coordinates of the vertex, nx, ny, nz are the coordinates of the vector normal to the surface at the vertex and Tu, Tv are coordinates of the texture map 8.

Now the texture map 8 can be thought of as the “skin” of the 3D object stretched out over a 2D map. The “skin” is placed back on the object by mapping coordinates of the texture map, Tu, Tv back onto the vertices of the triangles. The texture map is actually a two dimensional bit map, with each pixel defined by a location Tu, Tv, a color R, G, B, and other parameters such as opacity A and texture. In addition, it is common for each vertex to be associated with multiple texture maps.

This methodology of triangles and texture maps has resulted in some quality computer game simulations, but it has some significant limitations. First, a curved surface represented by triangles is not very smooth without very large numbers of triangles. This is particularly problematic when viewing a silhouette of a curved object such as the cylinder representation in FIG. 1. Due to typical memory and speed limitations, a curved surface may have noticeable facets, rather than being a smooth curve. Second, the texture map is memory intensive. This becomes particularly problematic when the user zooms (enlarges) a 3D surface. In such an event, the texture map/triangle representation will become obvious. To overcome this problem, zooming is accommodated by loading a new texture map. This is very processor intensive, and may slow the video game.

The usual approach to these limitations is to tailor the video game to optimize the use of the technology of triangles and texture maps. For example, shapes are chosen that are most easily represented by triangles—preferably surfaces bounded by straight lines. Zooming options are limited to avoid triangular artifacts or long load times for texture maps.

What is needed is a more flexible system for video games that enables the display of a wider range of geometries such as curved surfaces and more flexibility in zooming without sacrificing speed.

### SUMMARY OF INVENTION

The present invention is a system and method for migrating from a previous data structure for simulating surfaces of three dimensional objects to a new data structure that defines a surface of the three dimensional object in terms of contours. The contours sufficiently divide the surface such that an interpolative error between the contours is below a color error threshold and below a geometric error threshold.

### DRAWINGS

FIG. 1 is an illustration depicting a surface of a cylinder and then the prior art triangle method of approximating the surface of the cylinder.

FIG. 2 is an illustration depicting a single triangle of the prior art method of approximating surfaces with triangles and a texture map that is utilized to define the color and texture on the vertices of each triangle.

FIG. 3 is a block diagram of an image generating system of the present invention.

FIG. 4 is a flow chart that depicts the high level process for the present invention.

FIG. 5A is an illustration depicting a contour or “cut” being defined on a single triangle.

FIG. 5B is an illustration depicting how a contour or “cut” is being defined or mapped onto a plurality of triangles.

FIG. 6 is a flow chart representation of the method of converting a texture map into contours.

FIG. 7A is a flow chart depicting a “stray pixel” replacement process.

FIG. 7B-C illustrate an example of the stray pixel replacement process.

FIG. 8A is a flow chart representation of the process 102 from FIG. 2 where an initial pixel-based data structure is converted to a contour-based data structure.

FIG. 8B-1 is a graphical representation of a pixel-based representation of an image.

FIG. 8B-2 is a graphical representation of part of a contour-based representation of the image depicted in FIG. 8B-1.

FIG. 8C is a graphical representation of comparative plot of an actual color value versus position against a linear interpolation, of the color value versus position.

FIG. 8D is a graphical representation of an interpolative error function versus position for a linear interpolation of a color value.

FIG. 8E is the plot 4B-1 with a color contour 422 added.

FIG. 8F is a schematic representation of the neighboring pixels surrounding a pixel location 420.

FIG. 9 is a graphical representation of several splines that have been curve fitted to contours.

FIG. 10 is an illustration depicting how a contour from the pixel map is mapped into a single triangle.

FIG. 11 is a flow chart depicting how the contours and cut information is utilized to define primitives in the new data structure.

FIG. 12 is an illustration illustrating how primitives, as a combination of contour (including cuts) and cross-connects, are utilized to define a surface.

FIG. 13 depicts examples of several primitives.

FIG. 14 depict the rendering process associated with the present invention.

FIG. 15A depicts points that define single primitive

FIG. 15B depicts how additional points are added to the curved portions of a primitive boundaries to eliminate zoom and silhouette related visual artifacts from rendering.

FIG. 16A depicts an example of a cylinder and how it is broken into primitives for comparison with FIG. 1

FIG. 16B depicts in more detail a single primitive from the cylinder representation of FIG. 16A.

### DESCRIPTION OF A PREFERRED EMBODIMENT OF THE INVENTION

A preferred embodiment of the present invention is now described with reference to the Figures. Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, usually coupled to a computer system bus. Furthermore, the computers referred to in the specification may include a single processor or may be architectures employing multiple processors or other designs for increased computing capability.

The algorithms and displays presented herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

It is also noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

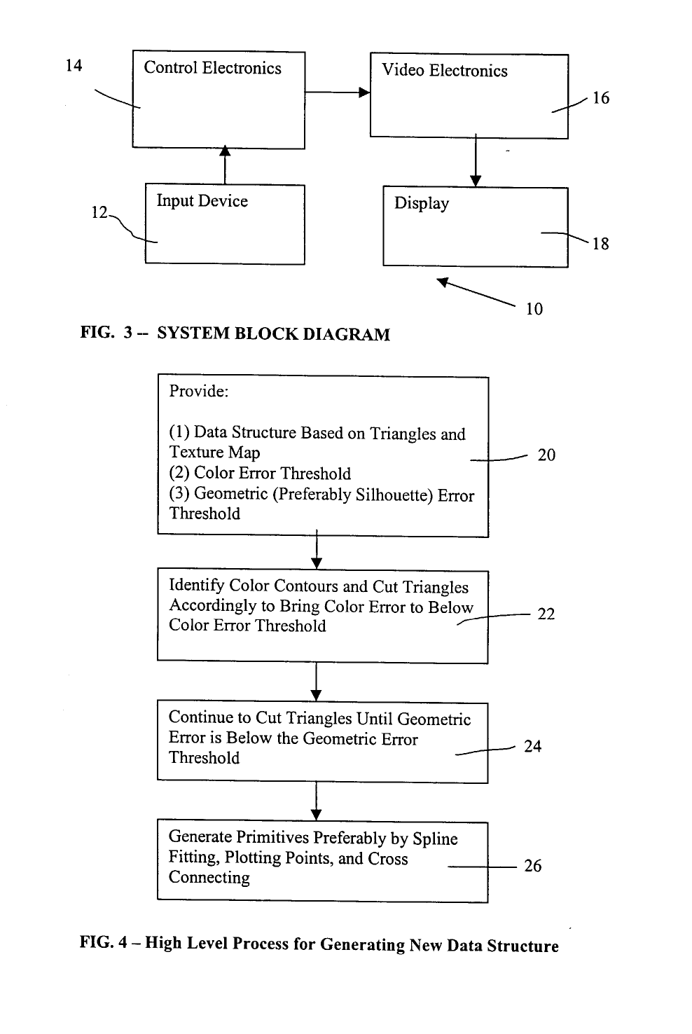

FIG. 3 depicts a block diagram of a system 10 incorporating the present invention. System 10 includes a user activated input device 12, such as a keyboard, joystick, mouse, buttons, touch screen (that is activated by touching the screen), electronic pen (that interacts with a display), etc. The input device is coupled to control electronics 14, that typically includes a processor and information storage device(s), such as RAM, CD-ROM, etc. The control electronics are coupled to video electronics 16, such as a video processor board. Together, the control electronics and video electronics can be referred to as a “video processing system” 17. This is because certain functionality can exist either in the control electronics or the video electronics without departing from the scope of the present invention. Finally, the video electronics 16 are coupled to and drive a display 18, such as a CRT, flat panel display, or a projector.

The user provides inputs to the control electronics 14 via the input device 12. In response, the control electronics 14 generates and modifies a data structure stored in the control electronics 14. The control electronics 14 generates point data from the data structure and sends the point data to the video electronics 16. The video electronics 16 in turn utilizes the point data to generate a graphical output representation of a 3D object on the display 18. It is understood that details of the interaction between control and video electronics is system dependent and variations of this are within the scope of the present invention. An exemplary system 10 would be a video game system, wherein the user uses the input device 12 to generate views of 3D objects from the video game on the display 18.

The present invention is a technique for obtaining a unique data structure representation of a 3D object from a previous data structure such as a triangle/texture map data structure. The new data structure allows very fast rendering of a 3D object while providing a very accurate color representation while avoiding noticeable visible silhouette or other geometrical artifacts. This new data structure also enables very fast scaling of 3D object views without loss of image quality.

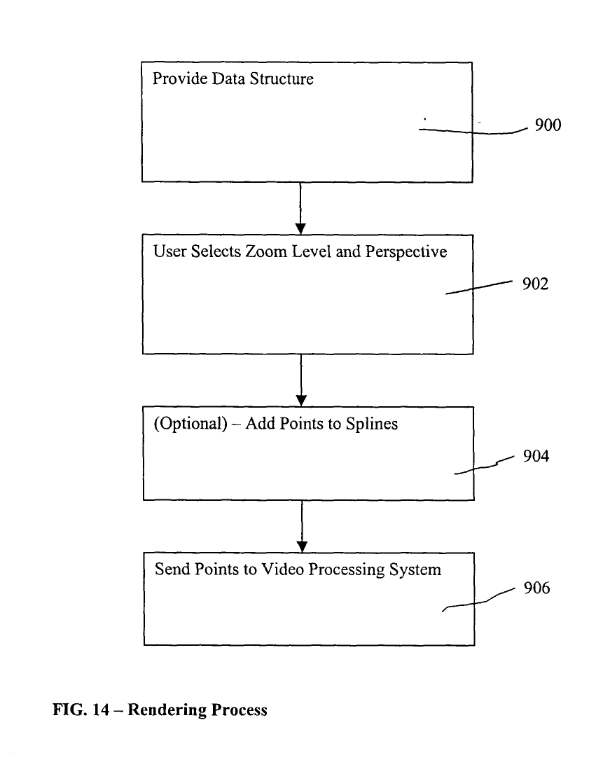

In the discussion that follows, the method of generating the data structure will first be discussed with respect to FIGS. 4-13 generally in order of increasing detail. Next, the rendering process is discussed with respect to FIGS. 14-16.

Because of the level of detail required to describe the process, the discussion begins with FIG. 4, which is a “high level flow chart” depicting the overall method of generating the new data structure. Each block (20-26) in FIG. 4 is referred to as a “process”, since it is later represented by more details later.

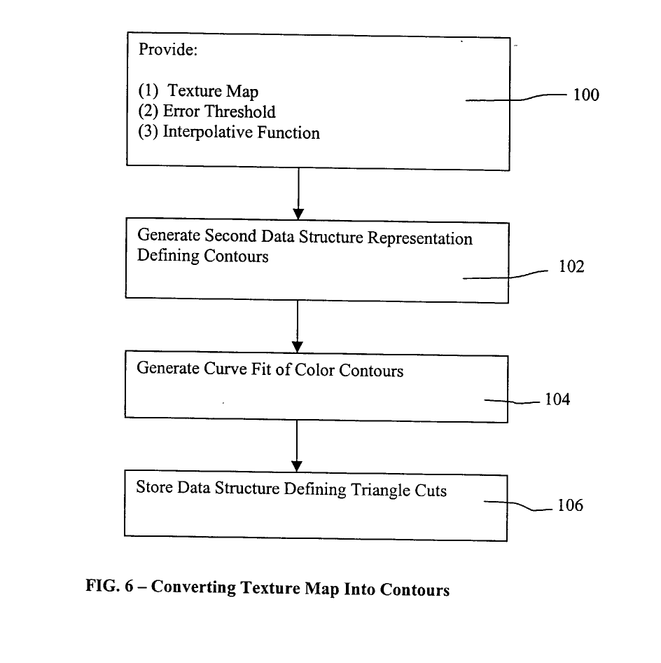

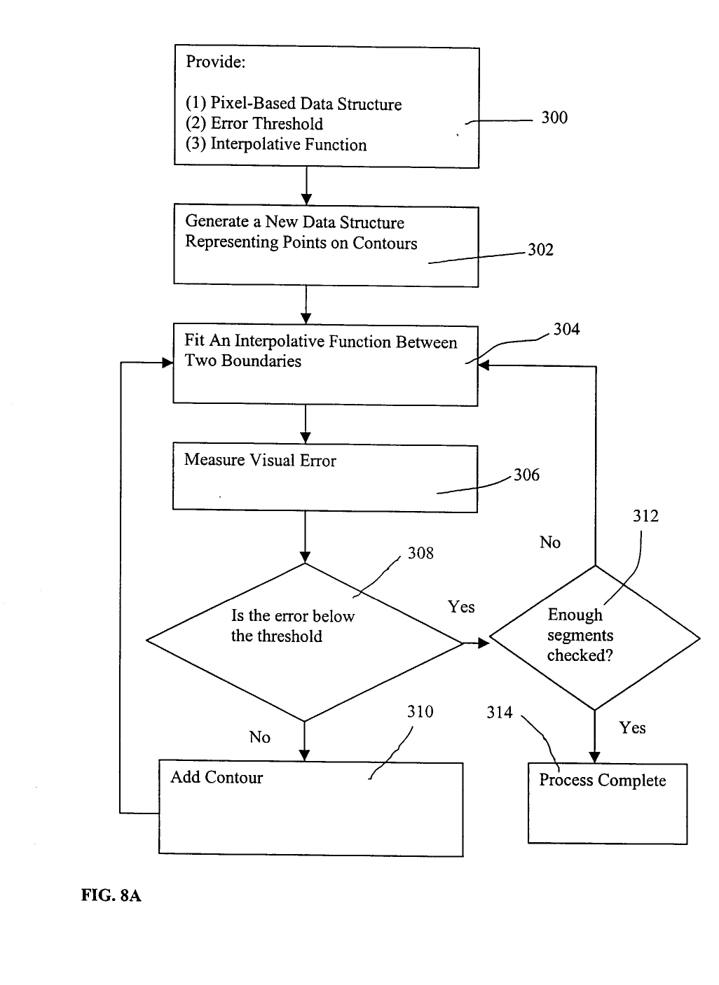

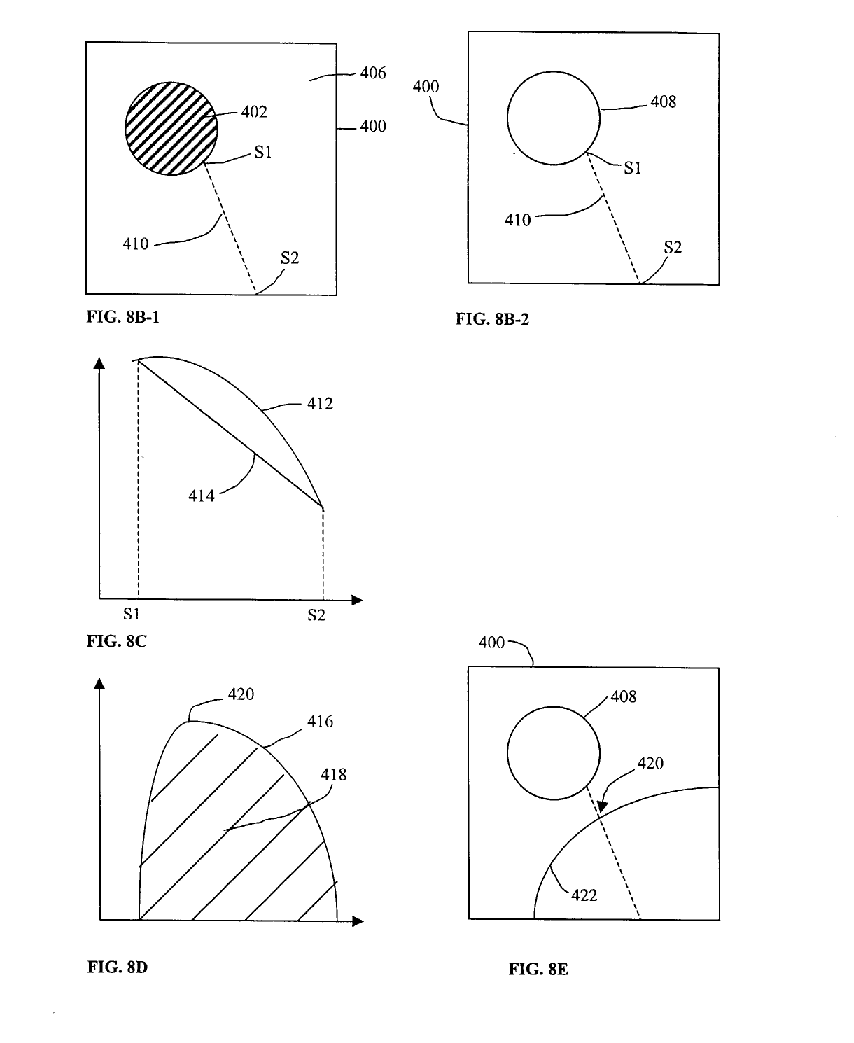

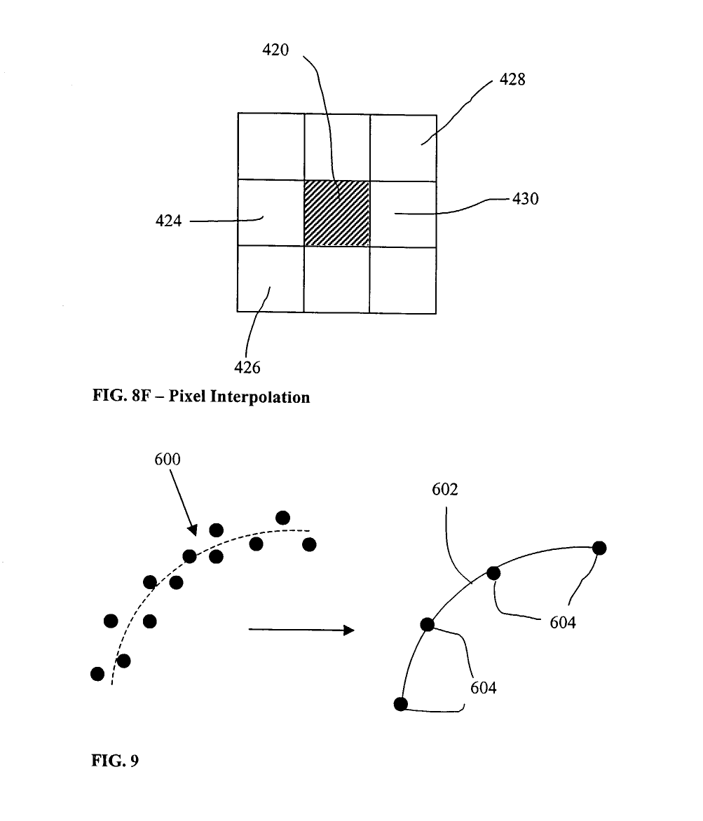

FIG. 6 is a flow chart representing process 22 of FIG. 4. Each block (100-106) is referred to as a “subprocess”. FIG. 8A is a flow chart representing an example of subprocess 102 of FIG. 6. FIGS. 8B-F provide further details of each of the steps of FIG. 8A.

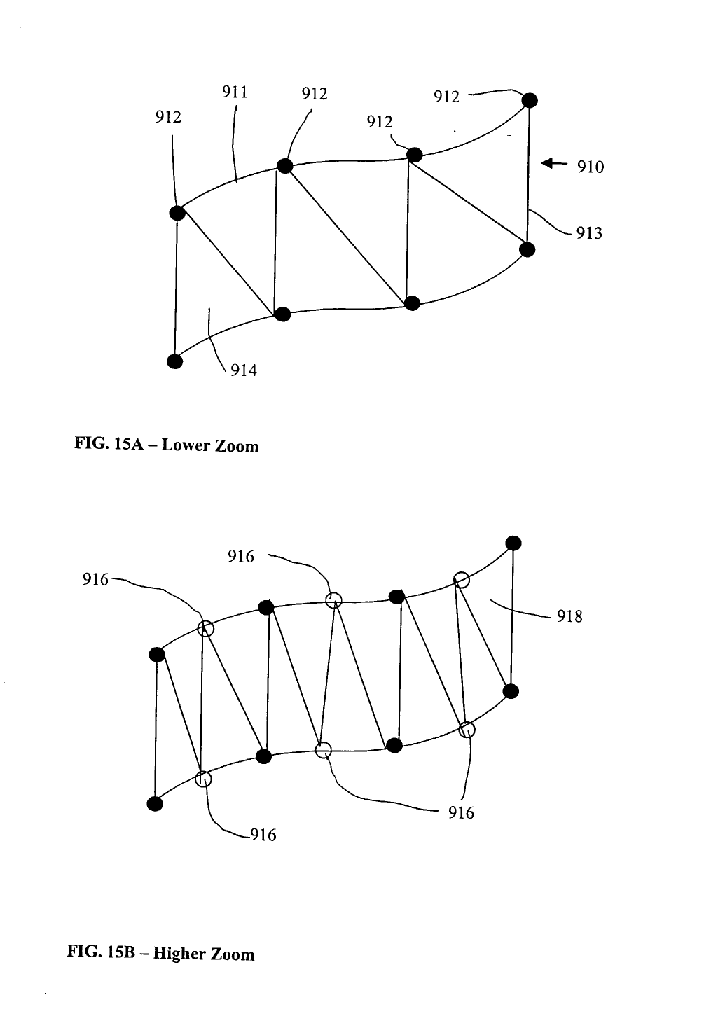

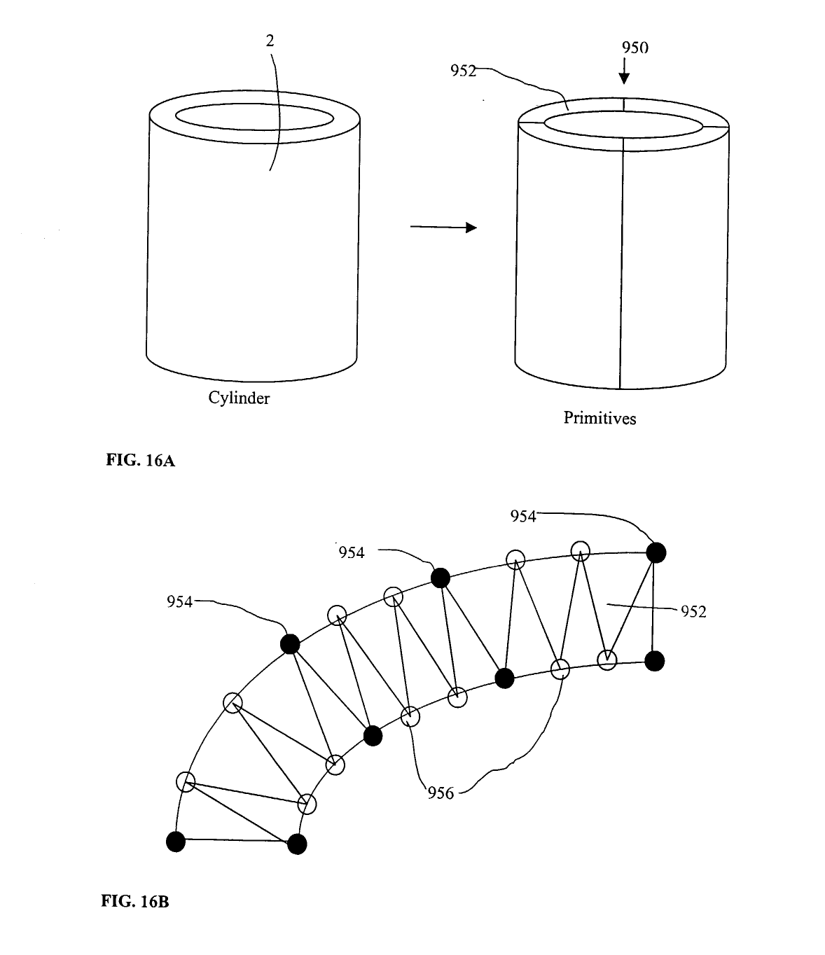

FIG. 11 is a flow chart representing process 26 of FIG. 4 that includes the remaining steps required for generating the new data structure of the present invention. Finally, FIG. 14 (along with illustrations in FIGS. 15-16) depicts the rendering process.

As stated above, FIG. 4 is a flow chart depicting the overall method of the present invention for converting from an older triangle/texture map data structure to a new data structure of the present invention. This new data structure provides smoother representations of curved surfaces while being much faster than the prior triangle/texture map system. The new system utilizes a new “primitive” representation of a 3D object.

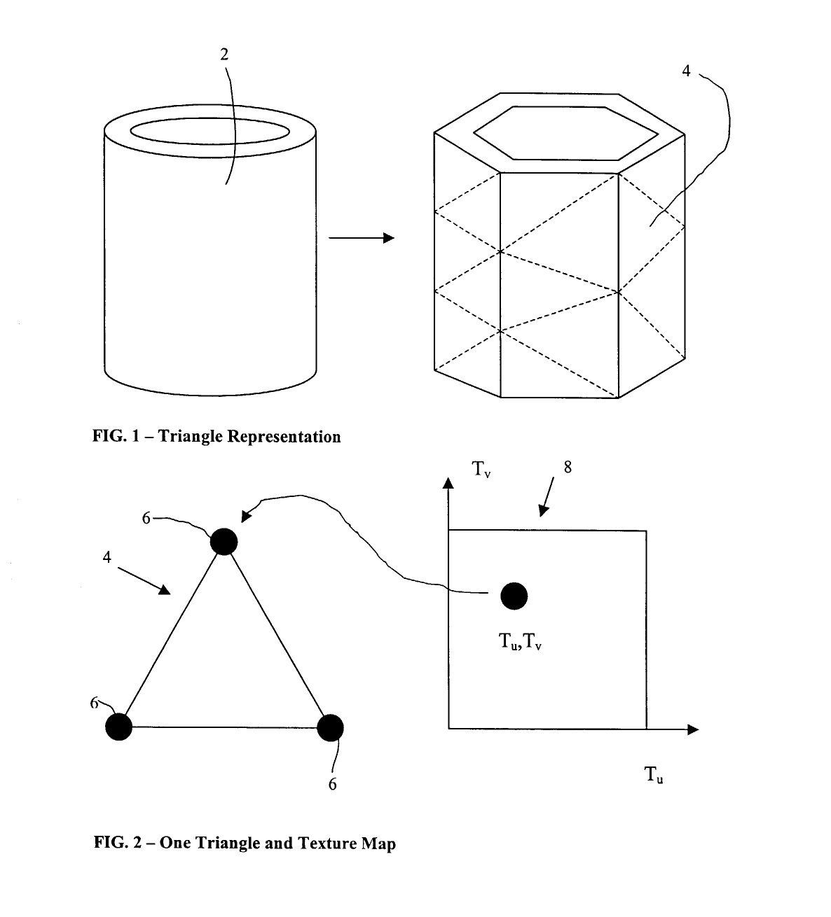

According to process 20 of FIG. 4, a previous data structure is provided that defines triangle vertices and a texture map, as depicted in FIG. 2. Also provided is a color error threshold and a geometric error threshold. The color error threshold is preferably a color accuracy required to represent the 3D object without visible artifacts or inaccuracies. The geometric error threshold is preferably an error threshold that avoids artifacts such as that depicted with respect to FIG. 1—wherein curved surfaces are noticeably segmented.

According to process 22, a new data structure is generated that defines contours on the 3D object. For at least some of these contours, each contour is a contour of (substantially) constant color wherein a color value is held to within a tolerance. These contours will tend to be used in regions of relatively slowly varying color or along the boundaries of objects.

A second type of contour has a color value that is maximized or minimized for points on the contour. This type of contour tends to be useful for representing texturized regions of rapidly changing color such as hair or grass. However, except as indicated, the following discussion will cover contours of constant color or contours following a path of least color change.

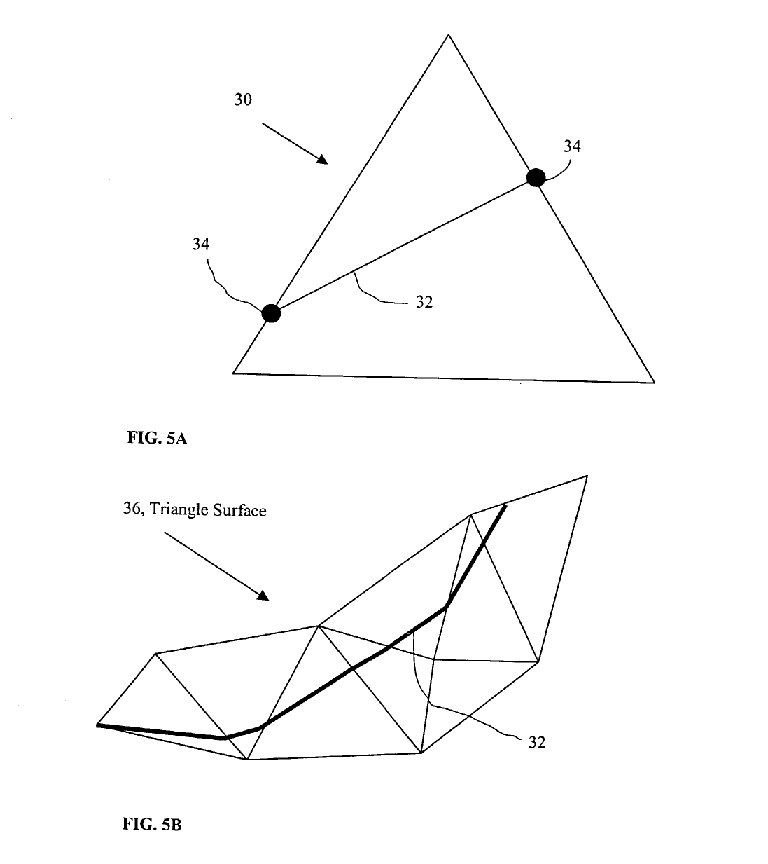

The contours are defined or identified by points on the triangle edges from a conventional data structure. This is depicted in FIGS. 5A and 5B. FIG. 5A depicts a single triangle 30 defined from a conventional data structure. The new data structure defines contours 32 of (substantially) constant color by storing points 34 from the edges of the original triangles. These contours “cut” the triangles into enough color contours such that an interpolation between the contours results in accurate color.

Returning now to FIG. 4, process 24 further cuts the triangle surface 36 (FIG. 5A) until a geometric error is below the geometric error threshold. This is particularly important to prevent artifacts such as that depicted with respect to FIG. 1.

In process 26, a primitive structure to replace the triangle system is defined by fitting splines to the color contours, defining points on the contours (that define the splines), and then defining cross-connect line segments that define the primitives.

At this point, further details will be discussed with respect to processes 22-26 of FIG. 4. FIG. 6 depicts a preferred method of process 22 of FIG. 4, including subprocesses 100, 102, 104, and 106. According to subprocess 100, the texture map is initially provided, along with the color error threshold and an interpolative function. The texture map represents the visible surface of the 3D object as pixels. Each pixel has position and color coordinates that are stored in the texture map data structure, such as (Tu, Tv, R, G, B), wherein: Tu=First rectangular coordinate of the pixel in the texture map; Tv=Second rectangular coordinate of the pixel in the texture map; and R, G, B=Red, Green, and Blue Values for the Pixel.

In the discussion that follows, reference is made to “color value”. In general, this could indicate any single color parameter that can be measured or calculated, such as red, green, blue, cyan, yellow magenta, luminance, chrominance, etc., or any combination thereof. However, in a preferred embodiment, the color value is actually in reference to three color parameters, such as Y (luminance), Cb (first chrominance parameter), and Cr (second chrominance parameter), or RGB.

The color error threshold is an important aspect of the method of FIG. 6. This is preferably a visible limit threshold, wherein errors above this threshold would be apparent to the human vision system. This threshold, to be described in greater detail below, can be tuned to achieve a desired quality for renderings from the compressed data structure of the present invention.

The interpolative function is a function used to interpolate between image boundaries. Preferably, this function is chosen to be consistent with standard video processing electronics. In an exemplary embodiment, this interpolative function is linear.

According to one preferred embodiment of the present invention, the color coordinates RGB are converted to YCbCr (luminance and chrominance) prior to process 102. However, process 102 and the subsequent processes could just as easily apply to RGB (red, green, blue) coordinates.

According to process 102, the pixel data is processed to define a new, more efficient data structure based on color contours. In a preferred embodiment, the new data structure defines the image in terms of points on contours each having a constant color value to within a tolerance. Preferably along each contour, Y, Cb, and Cr (or a combination thereof) are constant to within a specified overall tolerance. The number or density of contours is the minimum number or density required to provide an interpolative fit between contours that keeps the error in representing the original image below the error threshold.

In process 104, the contours are made smoother and the number of points required to represent them is reduced. This is done by fitting curves or splines along the contours. In process 106, the texture map contour representation is then mapped onto the 3D triangle representation. At this point, the triangle surface 36 is “cut” by the constant color contours.

At this point additional details of the a preferred embodiment of the method depicted with respect to FIG. 6 will be discussed.

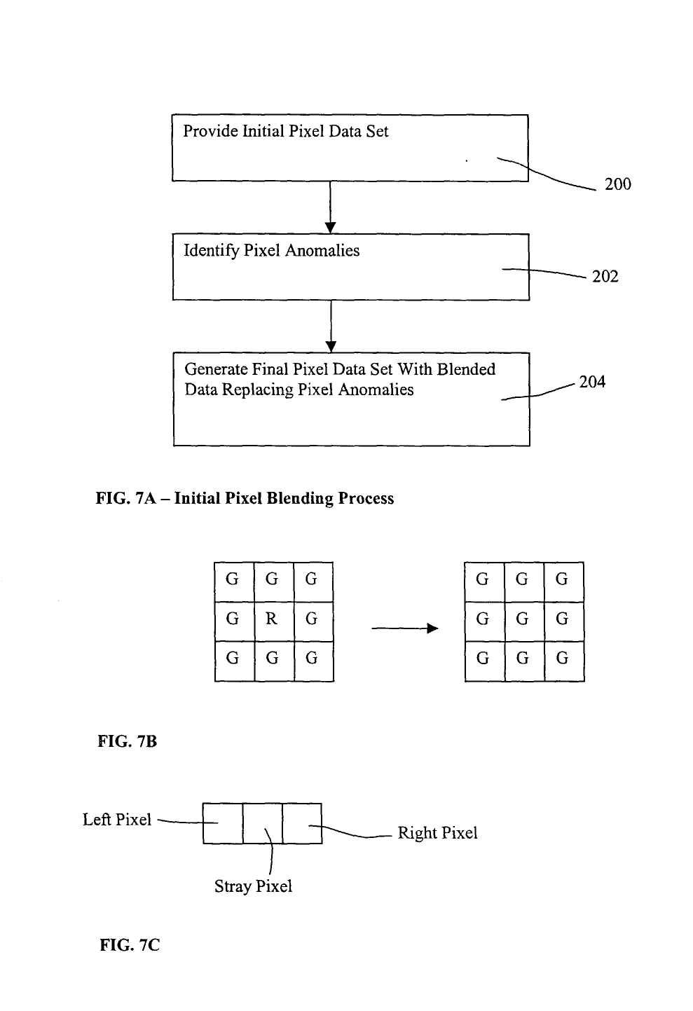

FIG. 7A is a flow chart depicting a preferred method that is utilized prior to subprocess 102 of FIG. 6. The purpose of this method is to improve the efficiency of subsequent processes by eliminating data that will not provide a better image representation. In step 200, the initial texture map is provided having a multiplicity of data elements, with each data element representing a pixel of an texture map, as illustrated in FIG. 7B, for example. Very often, there are anomalous or “stray” pixels that do not add any information discemable by the human eye. These pixels have a color that is substantially different than those surrounding them, as illustrated in FIG. 7C.

These stray pixels are identified in step 202. This can be done by comparing each pixel element color with the average color of pixels surrounding the pixel. When the difference is above a predetermined threshold or tolerance, then the pixel is a “stray” pixel. The stray pixels are replaced in step 204. The color of the stray pixel is replaced with the average color of some or all surrounding pixels. After replacing the stray pixels, the color space is converted from RGB to YCbCr.

Turning to FIG. 8A, a flow chart depicts a preferred embodiment of subprocess 102 from FIG. 6. The purpose of subprocess 102 is to replace a pixel-based texture map data structure with a contour-based data structure. In step 300, the pixel based data structure is provided. Preferably, this data structure has been “cleaned” to eliminate stray pixels according to the method of FIG. 7a. Also provided in step 300 is a color error threshold and an interpolative function. The color error threshold is related to an interpolative error calculation and is preferably close to the visible limit for the human vision system.

According to step 302, a new data structure is generated by defining points on contours that are either boundaries of objects, contours of least color change, or contours having color values that are either maxima or minima. In low density regions of an image, such as those representing smooth, curved surfaces, the contours are substantially constant color contours. In rapidly changing regions of an image that depict objects with fine texture—such as hair or grass—the contours follow peaks or valleys of the color surface. This minimizes the amount of data required to encode control points that control the contours. For many images or regions of images, the data structure defines points that are on contours of (substantially) constant color, which means that the color along a contour is within some predetermined limits. Stated another way, each point on the contour has a “color difference” (one version of this defined below as DC) relative to an average or defined color of the contour that is below a tolerance.

To explain this process further, some definitions are now set forth.

DC=Delta Color, or the “color difference”

DY=Difference in Luminance

DCb=Difference in value for Cb

DCr=Difference in value for Cr

DC=sqrt(DYˆ 2+DCbˆ 2+DCrˆ 2), where:

sqrt()=the square root of the quantity in brackets

DYˆ 2=the square of DY

DCb=the square of Cb

DCr=the square of Cr

For points included on a contour having a substantially constant color value, the present invention has: DY=Y(contour)−Y(point), where Y(contour) is the average or assigned luminance for the contour and Y(point) is the luminance value for the particular point.

Similar definitions hold for Cb and Cr. Now for the contour, the value for DC for each point is included on the contour below a certain error threshold value.

In a preferred embodiment of step 302, the original pixel map defined by the pixel-based data structure is initially scanned to find regions in x and y of substantially constant color. These regions are then represented in the new data structure as points forming closed color contours that surround the regions of constant color.

This preferred embodiment of step 302 is depicted with respect to FIGS. 8b-1 (old data structure texture map) and 8b-2 (new data structure contour map). The old data structure stores a 5 (or more) dimensional value for each pixel. As indicated before, each point on the image would have a value of Tu, Tv, R, G, and B. (or Tu, Tv, Y, Cb, Cr after the color conversion). Other factors may also be stored, such as opacity and texture, but for ease of discussion, the following description presumes a 5 dimensional system recognizing that other dimensions may be stored for each point. The points represent the original image depicted in 8b-1, that includes a border 400, a region of constant color 402, and a region of varying color 404.

To begin with, the pixel array of 8b-1 is scanned (by analyzing the 5 dimensional pixel data) and the region 402 is identified (as a region where the color is the same to within a predetermined tolerance, wherein one method of calculating it is defined above). A new data structure is then generated that includes data representations of points on the border 400 of the pixel array. The new data structure also includes a set of points defining a closed contour 408 that enclose the region of constant color. The Y, Cb, and Cr values for each point on the contour 408 are the same as the Y, Cb, and Cr values for the region 402 (again to within some predetermined limit or tolerance).

In a preferred embodiment process 104 of FIG. 6 is then invoked. Each time a contour is formed, an optimized curve or spline is fitted through portions of each contour. The data structure is then modified to only include the minimum number of points that are referred to as “control points” required to plot the resultant splines. This results in another compression of the data since only the control points of the curves or splines will be stored in the data structure. This process will be discussed further with respect to FIG. 9. However, before that, a description of FIG. 8a is set forth.

At this point, an interpolative fit is carried out between two image boundaries according to step 304 of FIG. 8a. An image boundary is defined by a contour (such as 408 in FIG. 8b-2) or the border (such as 400 of FIG. 8b-1) of the contour map. In an exemplary embodiment, this is done by comparing a plot of color versus position between two points on the original pixel array with a linear fit between the same two boundaries on the contour map. This is done for Y, Cb, and Cr.

In a preferred embodiment, this is done by “plotting” color versus position along a line that is perpendicular to a contour of constant color, since that is the direction of maximum change (the gradient) for the color and hence the most efficient way to identify color change. A conceptual example of this is segment 410 from FIGS. 8b-1 (defined by the old pixel-based data structure) and 8b-2 (defined by new contour-based data structure). This step optimizes the placement and number of contours for further compression.

Exemplary superposed plots for a “color value” is illustrated in FIG. 8c, including the plot for the actual color 412 and the linearly interpolated color 414. This plot could be for Y, Cb, and Cr. For simplicity in this example, only one color variable is considered, but understand that preferably the comparison of actual and interpolated color are done for all of the components, including Y, Cb, and Cr simultaneously.

As depicted in FIG. 8D, the actual value “plotted” would be an interpolative error function 416 versus position. The interpolative error function is the degree to which the actual color at a point differs from the linearly interpolated color at that point. In an exemplary embodiment, this is the value DC, or “color difference”, defined above, where: DC=“Color Difference” between interpolated color and actual color from 8b-1 at a point; DY=Difference between interpolated value of Y and value of Y from 8b-1; and the same definitions are used for Cb and Cr.

Now according to step 308 the interpolative error of the linear interpolation is calculated. In an exemplary embodiment, this is defined roughly as the area 418 under the interpolative error function curve 416, and can be estimated as follows:

Interpolative Error=DC times length of segment between S1 and S2 divided by two.

Note that the interpolative error function is based upon a visible limit function which describes the visibility of the error as described herein.

According to step 308, this error is compared to the error threshold (from step 300). If the interpolative error (defined by area 418) is above the error threshold, then a contour is generated according to step 310.

According to one embodiment, one point on the contour (to be generated) is the point associated with the maximum error 420. The color value associated with the contour is the color at point 420. This point 420 is also depicted in FIG. 8e. The next step is to find “connecting” points that have substantially the same color value as point 420. This is done in two directions to generate a substantially constant color contour 422.

Finding new points is done by scanning pixels (from the original pixel based data set) in the vicinity of point 420 to see which ones match the color value of point 420 (to within a tolerance). In most cases, the color value may not exactly match 420 on any one pixel. This can be resolved by interpolating between pixels. Hence, the resultant contour points may not fall exactly on pixels, but may fall between pairs of pixels based on a weighted average color that matches the color of point 420.

For example, consider FIG. 8f, wherein the point 420 is a pixel location as surrounded by 8 neighboring pixels. Pixels 424, 426, 428, and 430 are the neighboring pixels closest in color to point 420. Thus, a new point on contour 422 will fall between pixels 424 and 426, with an exact location depending on which pixel has a color closer to that of 420. In this interpolative manner, two new points on the contour 422 are then found. This process is continued for each of the new points, until all of the points on contour 422 are found. Contour 422 may end at the edge of edge 400 of the contour map or when no more points can be found that are the same color as 420 within a specified tolerance.

Once a new contour has been added, steps 304-308 of FIG. 8A are repeated. When an error is found to be less than the visible error threshold in step 308, then the test in step 312 is invoked to determine if there are any untested segments left. If so, then the process of steps 304 to 308 or 310 continues until “all segments” have been tested to be below the error threshold. A reference to “all segments” means that the testing has been done to a density (such as partial or full pixel density) to assure that the color accuracy level defined by the error threshold has been met. When all segments have been tested according to step 312, the present invention moves to step 314 wherein the requirements of process 102 (of FIG. 6) have been met.

Before going to on to the process 104 of FIG. 6, some discussion about possible variations for FIG. 8A is appropriate. Where the present invention is described using Y, Cb, and Cr as the color coordinates, the process will also work reasonably well with coordinates RGB, CMY, LAB, or any other coordinate system. There are also other ways of carrying out this process.

For example, following step 300, the present invention could start by defining the border 400 in the new data structure consistent with step 302. Next, according to steps 304-308, for each row (or column) of pixels (starting with row 1, column 1, or a middle row or column, for example), the error plot like that in FIG. 8D can be generated. This differs from the earlier discussion where the error function was generated perpendicular to the tangent to a contour. According to step 310, a contour can be generated from the point of maximum error for the error function. This alternative embodiment for the process of FIG. 4A may yield contours in different locations, but still embodies the method of the present invention.

In addition to contours of substantially constant color, it may be advantageous to identify contours that are on edges of physical objects (being depicted in an image) or contours that represent minima or maxima in terms of color parameters such as Y. These contours are likely to be used along with contours of substantially constant color as per the methods described with respect to FIG. 8A.

As stated before, preferably when each contour is generated, spline(s) are fitted to the contour to compress the data structure and to facilitate mapping the contour back to the triangle representation of the old data structure. This is illustrated with respect to FIG. 9. Each color contour is initially a set of points 600 on the texture map that have been found by the search function depicted with respect to FIG. 8F. Splines, such as the cubic spline 602 are then fitted to the points 600. For the example in FIG. 9, the spline 602 can then be represented with four control points 604.

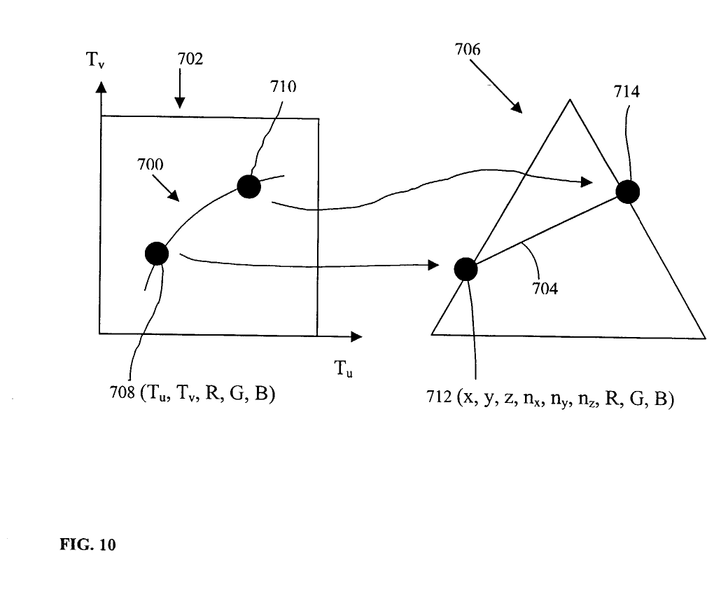

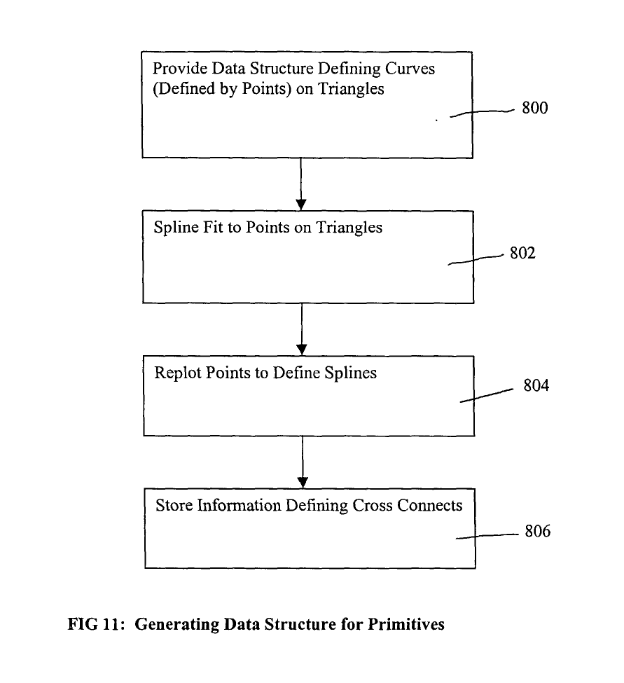

Referring back to FIG. 6, a new data structure is generated with respect to subprocess 106. This is illustrated with respect to FIG. 10 that depicts a contour 700 plotted in the dimensions of the old texture map 702 and a portion 704 of the contour plotted in on edges of a triangle 706. The points 708 and 710 from the Tu, Tv space of the texture map are mapped into points 712 and 714 respectively. Of course, variations of this method are possible. For example, subprocess 104 of FIG. 6 could be eliminated and contour points generated from subprocess 102 could be mapped directly back to the xyz, nx, ny, nx, RGB space of the triangles (by looking for points on each contour that most closely fall upon triangle edges in an iterative manner.

When process 22 of FIG. 4 (or the entire process of FIG. 6) is complete, then the present invention has a new data set defining contours in x, y, z, nx, ny, nz, R, G, B that have a substantially constant color value and with a contour density to keep the color error below a preselected error tolerance. However, there are still geometric errors. Thus, process 24 is invoked whereby the triangles are further “cut” until angular change from one cut to another is below a certain preselected value. This may be some value, such as 5 degrees, or 10 degrees, and is determined by looking at the nx, ny, nz values along each color contour and cutting the triangles until there are enough contours such that there is less than a certain angular change between cuts.

At this point, the present invention invokes process 26 of FIG. 4, which is depicted in more detail with respect to the flow chart of FIG. 11. The present invention starts out with the data structure defining “cuts” in triangles, according to step 800. The actual data structure to be worked with is the set of points intersecting edges of the triangles, such as edge intersecting points 712 and 714 depicted in FIG. 10 for triangle 706.

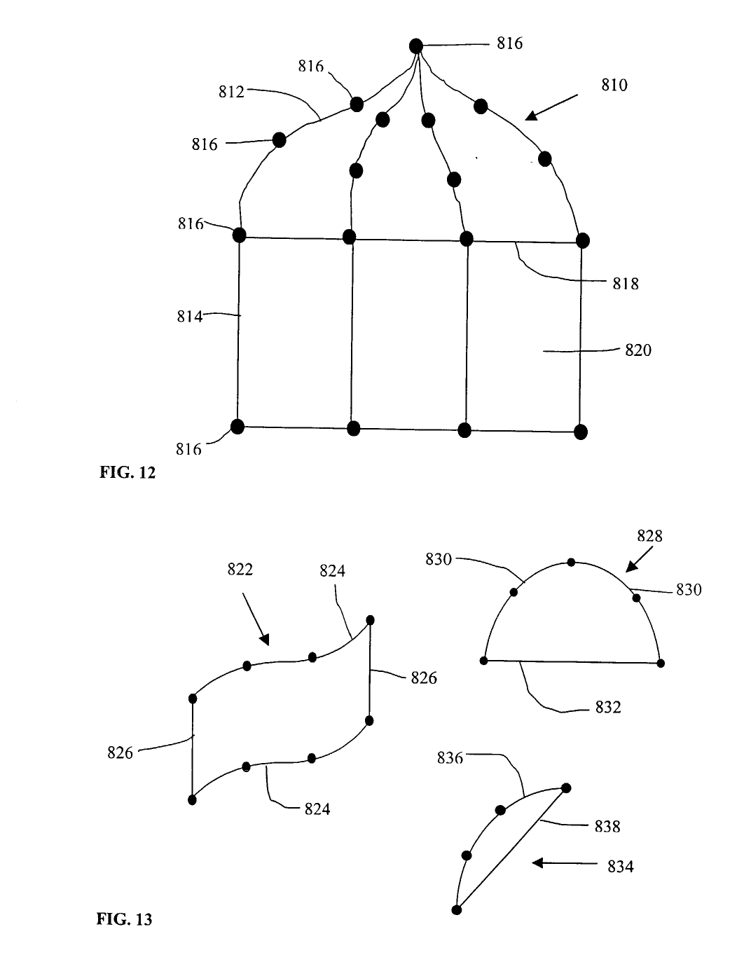

According to step 802, splines are fitted to the edge intersecting points. An exemplary representation of the resultant data structure is depicted with respect to FIG. 12 for an arbitrary object 810. The order of the splines chosen depend on a best fit to the particular set of triangle intersections. For example, spline 812 is a cubic spline. On the other hand, spline 814 is a linear. In general, splines can be linear, quadratic, cubic, or higher order. However, in a preferred embodiment, the spline order is selected from the set of linear, quadratic, or cubic.

According to step 804 of FIG. 11, the new data structure stores the points 816 (in x, y, z, nx, ny, nz, R. G, B, etc. -space) that are required to define each of the splines that fit to the surface of the 3D object being represented. These points replace the previous points that defined intersections with triangles. For example, four points 816 are required to represent the cubic spline 812, but only two points are required to represent the linear spline 814.

Next, according to step 806, cross connects 818 are defined in the data structure that, together with the splines, define closed regions called “G-patches” or “primitives” 820. In this new data structure, primitives can be thought of as the basic building block of a 3D surface. Thus, the surface of the 3D object from the video game is represented by a plurality of primitives. The primitives are surfaces enclosed by a combination of splines and linear cross connects.

Some examples of some primitives are illustrated with respect to FIG. 13. Primitive 822 is defined by a combination of two cubic splines 824 and two cross-connects 826. Primitive 828 is defined by a combination of two quadratic splines 830 (each defined by three points) and one cross-connect 832. Primitive 834 is defined by a cubic spline 836 and a cross-connect 838.

A rendering process for the present invention is depicted with respect to FIGS. 14-16. At step 900 of FIG. 14, the present invention starts with the new data structure that defines a plurality of primitives that define the surface of a 3D object. According to step 902, the user provides inputs to the system that determine the view and zoom for the 3D object. FIG. 15A depicts one primitive 910 of the plurality of primitives bounded by splines 911 and cross-connects 913. This primitive is defined by control points 912 stored in the data structure. At this point, the point data from control points 912 can be sent to the video processing electronics for generating an image on display 18 according to step 906. The display will display triangles 914, with the color for each triangle interpolated between the three corners of the triangles.

An optional step 904 can also be invoked. If the user zooms in on a surface too much, the edges of triangles 914 can become apparent. This is particularly problematic for curved edges or silhouettes of 3D objects. To avoid a triangle-based artifact, additional points 916 are added between the control points 912 on splines 911 according to FIG. 15B. When these additional points are sent to the video processor (along with curve defining points 912), the resultant triangles 918 are smaller and define the curved splines 911 better.

FIG. 16A depicts an example of a cylinder generated by the method of the present invention. Cylinder 2 (from FIG. 1) is illustrated again along with a representation 950 of the cylinder according to the data structure of the present invention. Comparing this to the triangle representation of FIG. 1, it can be seen that two surfaces of the cylinder can be represented with far fewer primitives (6) than triangles (about 20). In addition, the primitives provide a far more smooth representation of the curved surfaces of the cylinder 2. For example, primitive 952 is bounded by two cubic splines and two linear cross connects.

Primitive 952 is illustrated in enlarged form in FIG. 16B to illustrate the rendering method. The splines bounding primitive 952 are defined by eight control points 954. In addition, some additional points 956 have been added to the splines between the control points to improve the resultant rendered image. Of course, more or less points can be sent to the video processor electronics depending on the level of zoom for the cylinder 2.

The present invention represents a considerable advance over the old systems for displaying video games. By utilizing primitives that are bounded by a combination of splines and cross-connects, curves can be represented without a “facet” appearance such as that depicted in FIG. 1. Video game designers will no longer need to tailor their video games to the limitations of triangles and texture maps. By replacing the texture maps with color contours, a significant memory and processor speed improvement is also realized.

While the invention has been particularly shown and described with reference to a preferred embodiment and several alternate embodiments, it will be understood by persons skilled in the relevant art that various changes in form and details can be made therein without departing from the spirit and scope of the invention.

What we claim is:

1. Given a triangle/texture map data structure representation of a surface of a 3D object, a method of making, and of using for display of the 3D object, a new data structure representing the same surface of the same 3D object, the method comprising:
from data of the triangle/texture map data structure representation of a surface of a 3D object, defining so many contours,
where each contour is of multiple substantially equivalent locations upon the surface of the 3D object,
where the collective contours dividing the surface of the 3D object, as will provide of an interpolated fit between contours that will keep error in any visual representation of the 3D surface of the object from the contour data below a predetermined threshold error; and
displaying a visual representation of the surface of the 3D object from the contour data.

2. The method according to claim 1 where the multiple substantially equivalent locations of each contour are so equivalent by being of color differing by less than a predetermined tolerance called a color tolerance.

3. The method according to claim 1 further comprising:
fitting curves, or splines, along the contours in order that the number of locations required to represent a least some contours is reduced;
wherein by this fitting of splines the total locations of all the collective contours are abbreviated, or compressed, from the triangle/texture map data structure from which the contours are derived.

4. The method according to claim 3
wherein splines are fitted in numbers such that any geometric error in the displaying of the visual representation of the surface of the 3D object from the contour data will be below a predetermined threshold value, called a geometric error threshold.

5. The method according to claim 3
wherein the fitted splines are linear.

6. The method according to claim 3
wherein the fitted splines are non-linear.

7. The method according to claim 3
wherein the fitted splines are both linear and non-linear.

8. A method of generating a new data structure from a previous data structure for representing the surface of a 3D object, the method comprising:
providing a color error threshold;
providing a geometric error threshold; and
finding contours that sufficiently divide the surface of the 3D object such that an interpolative color error between the contours is below the color error threshold and an interpolative geometric error of the 3D surface is below the geometric error threshold.

9. The method of claim 8, wherein the contours include color contours.

10. The method of claim 8, wherein the previous data structure includes a pixel-based texture map and wherein the color contours are derived from the texture map.

11. The method of claim 10, wherein the previous data structure approximates the surface of the 3D object with polygons, and further comprising utilizing the contours from the texture map to define linear segments of the contours on the polygons.

12. The method of claim 8, wherein the previous data structure approximates the surface of the 3D object with polygons, the contours defining linear segments that divide surfaces of the polygons.

13. The method of claim 8, wherein the previous data structure approximates the surface of the 3D object with polygons, the contours defining points on edges of the polygons.

14. The method of claim 8, wherein each contour dividing the 3D surface defines one or more splines.

15. The method of claim 14, wherein each spline is either linear, quadratic, or higher order.

16. The method of claim 14, further comprising: utilizing the data from the previous data structure to define linear cross-connects, wherein the contours and cross-connects define closed primitives.

17. A method of generating a new data structure from a previous data structure, the previous data structure defining a surface of a three dimensional object with polygons, the method comprising:
finding a plurality of points on at least some of the polygons that define at least one contour, the at least one contour having a color value that is constant to within a tolerance.

18. The method of claim 17, wherein finding a plurality of points on at least some of the polygons includes finding points on some of the edges of the polygons.

19. The method of claim 17, further comprising fitting at least one spline through the plurality of points on the polygons.

20. The method of claim 19, further comprising storing points defining the at least one spline in the new data structure.

21. The method of claim 19, wherein the number of points stored for defining the at least one spline is approximately the minimum number to define the at least one spline to minimize file size and memory requirements, minimize transmission time over a network, or maximize rendering speed for the new data structure for a given image quality.

22. A data structure for representing the surface of a 3D object, the data structure including control points that define contours that divide the surface into subregions, the contours including contours of substantially constant color.

23. The data structure of claim 22, wherein at least some of the contours define maxima or minima for the color values within a region of the image having high rates of color change.

24. A method of rendering a representation of a three dimensional object comprising:
providing a data structure for representing the surface of a 3D object, the data structure including control points that define contours that divide the surface into subregions, the contours including contours of substantially constant color;
defining connections between the contours to form polygons.

25. The method of claim 24, wherein the represented 3D object is an object, character, or surface in an interactive video game, entertainment system, educational system, or training simulation.

26. The method of claim 24, wherein the represented 3D object is an an object, character, or surface in an advertisement.

27. The method of claim 24, wherein the represented 3D object is an an object, character, or surface in a computer-aided design system.
